(19) United States
(12) Patent Application Publication
(10) Pub. No.: US 2021/0188045 A1
(43) Pub. Date: Jun. 24, 2021

(54) AIR CONDITIONING KIT FOR VEHICLES

(71) Applicant: AUTOCLIMA S.P.A., Cambiano (IT)

(72) Inventor: Matteo GUERCIO, Orbassano (IT)

(73) Assignee: AUTOCLIMA S.P.A., Cambiano (IT)

(21) Appl. No.: 16/761,860

(22) PCT Filed: Nov. 17, 2017
(86) PCT No.: PCT/IT2017/000258

§ 371 Date: May 6, 2020

(51) Int. Cl. B60H 1/32; B60H 1/00

(52) U.S. Cl. CPC B60H 1/323; B60H 2001/3292; B60H 2001/3272; B60H 1/00378

(57) ABSTRACT

An air conditioning kit for vehicles, comprising:
an auxiliary compressor, which can be powered with an energy source that is independent of the engine and which optionally coincides with the original battery of the vehicle, the auxiliary compressor being interposed between an intake branch and a delivery branch,
a first connector, for the connection of the intake branch to the intake conduit, defined by the circuit, of the primary compressor,
a second connector, for the connection of the delivery branch to the delivery conduit, defined by the circuit, of the primary compressor,
an apparatus for intercepting at least a part of the lubricant that is usually dispersed in the heat carrier fluid, in order to prevent the complete emptying of lubricant in the primary compressor and/or in the auxiliary compressor.

The present invention relates to an air conditioning kit for vehicles.

As is known, most vehicles are provided with a preinstalled air conditioning (or climate control) system, which is connected to the internal combustion engine of the vehicle proper and is intended to ensure better environmental conditions for the driver.

More precisely, a system of the type described above is capable of executing a refrigeration cycle and it is made up of at least a compressor, an evaporator, a condenser and a dehydrating filter. The compressor is entrained in rotation by the engine (which therefore is responsible for supplying the work necessary for the cycle), typically by way of a belt. The evaporator is arranged inside the vehicle, in the cab or in the driver and passenger compartment, to remove heat and ensure better environmental conditions. The condenser is located outside, and usually it is cooled with the fan of the radiator.

A system of the type described above is designed to operate only during the motion of the vehicle, in that, as has been seen, it is actuated by the internal combustion engine that entrains the compressor in rotation.

It should be noted however that the drivers of vehicles for professional use, such as trucks, semi-trailer trucks and the like, often make long stops while driving, to rest or even sleep in the cabin of the vehicle.

During such stops, the need is still felt to control the environmental conditions of the cabin, as occurs during the movement of the vehicle, but such need cannot be met by the system described above, because the engine is switched off.

Therefore, in order to overcome the limitation of such type of system, various companies have offered independent air conditioning units on the market for spare parts and accessories, which can be anchored to the cabin in various ways and which are provided with all the necessary components for the execution of a refrigeration cycle and the corresponding power supply.

Such units can be hung outside the cabin, and connected to the compartment to be climate-controlled by way of a hole made in a wall. In other cases, the units are mounted above the cabin, at a hatch with which vehicles are sometimes provided.

Recently, the companies that produce such units have seen their business volume progressively reduced, in that the makers of the vehicles have offered solutions on the market whereby the factory-installed air conditioning system is already provided with an integrated parallel, independently-powered circuit that can operate when the engine is switched off.

Such integrated solution undoubtedly offers significant advantages, first of all in terms of reducing the number of components required, and therefore also in terms of reducing the weight.

Furthermore, the integrated solution does not require the assembly of units or components outside the cabin (exposed to damage, theft or tampering), still less the provision holes in the walls of the cabin or the use of the hatch, if provided in the vehicle, which can therefore be left available for other uses. In addition, the absence of elements outside the cabin keeps the aerodynamic profile of the vehicle unaltered, thus countering an additional problem that is very much felt in independent air conditioning units.

The aim of the present invention is to provide a kit for the air-conditioning of a compartment of a vehicle when the engine is switched off, which can be effectively installed on vehicles already in circulation but which still offers the advantages of the integrated solutions.

Within this aim, an object of the invention is to provide a kit that can be installed on a vehicle, without requiring holes in walls or the use of hatches, and more generally without entailing elements mounted outside the cabin and therefore without modifying the aerodynamic profile of the vehicle proper.

Another object of the invention is to provide a kit that makes it possible to reduce the number and weight of components required overall for the air-conditioning of the passenger compartment or of the driver's cab, when the engine is running or switched off.

Another object of the invention is to provide a kit that ensures a high reliability of operation, as it can in any case be operated independently of the preexisting air conditioning apparatus.

Another object of the invention is to provide a kit that adopts an alternative technical and structural architecture to those of conventional kits.

A still further object of the invention is to provide a kit that can be easily implemented using elements and materials that are readily available on the market.

Another object of the invention is to provide a kit that is low cost and safely applied.

This aim and these and other objects which will become better apparent hereinafter are all achieved by a kit according to claim 1.

Further characteristics and advantages of the invention will become better apparent from the description of a preferred, but not exclusive, embodiment of the kit according to the invention, which is illustrated by way of non-limiting example in the accompanying drawings wherein:

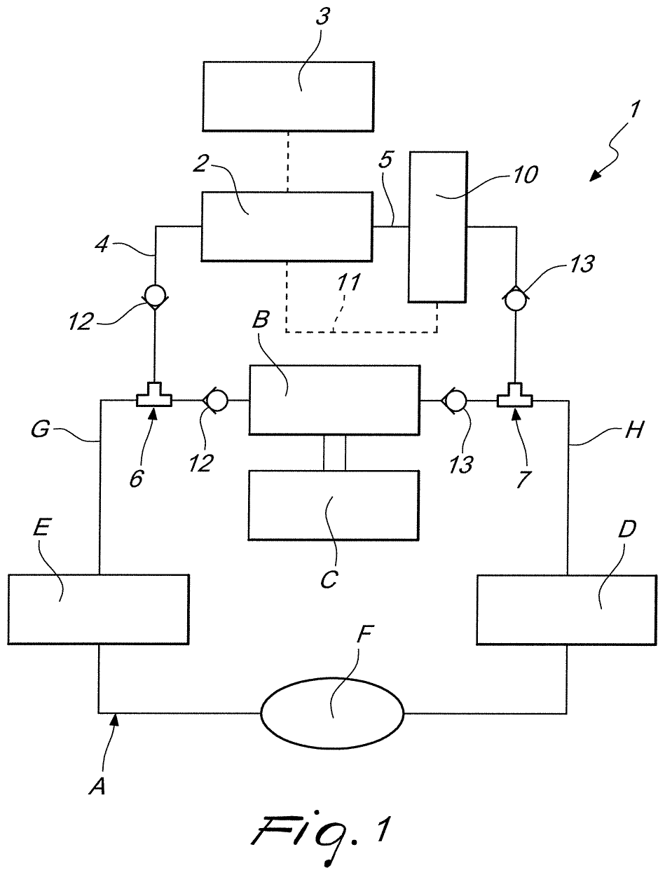

FIG. 1 is a block diagram of a possible embodiment of the kit according to the invention;

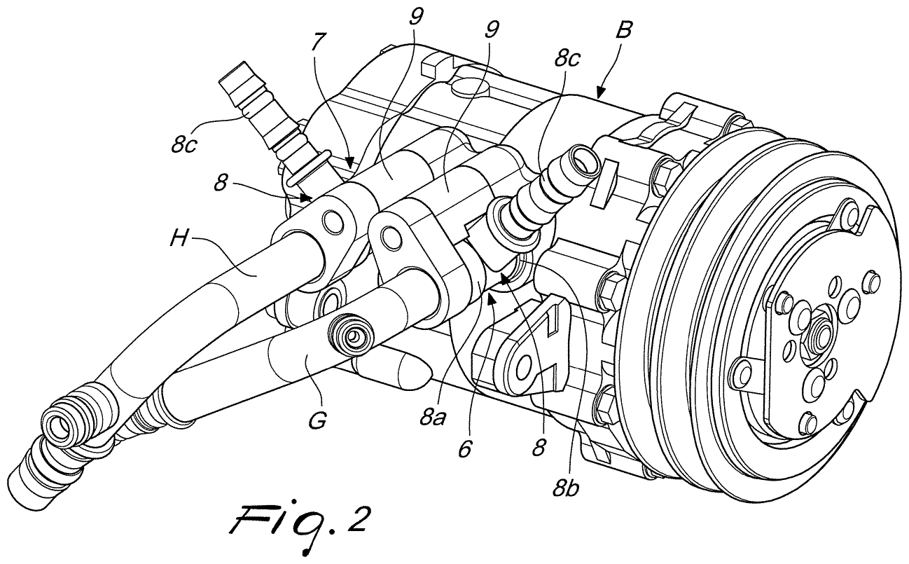

FIG. 2 is a perspective view of a mode of connecting the connectors to the primary compressor and to its intake and delivery conduits;

FIG. 3 is a front elevation view of one of the connectors in FIG. 2,

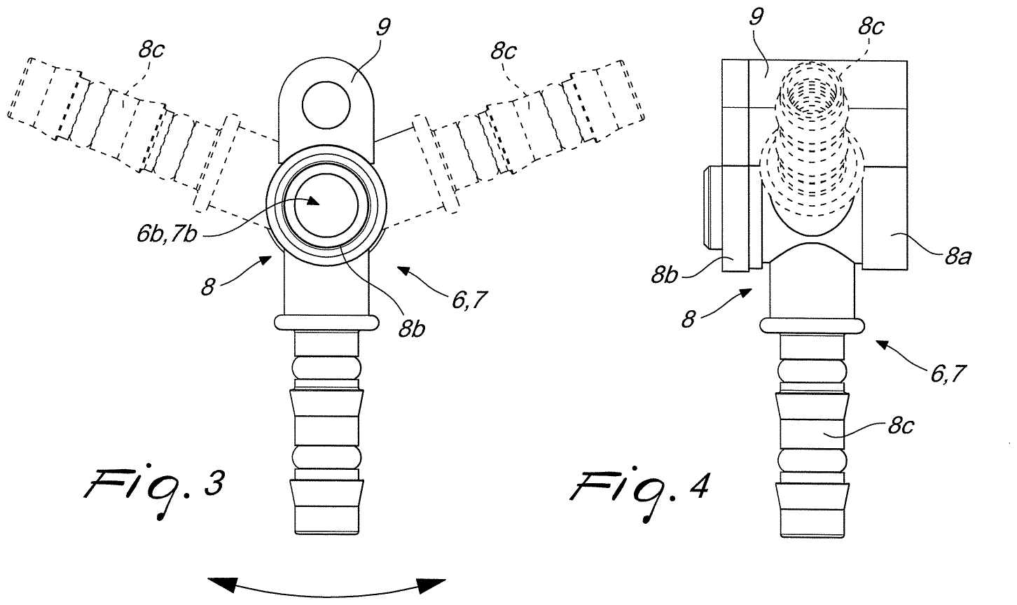

FIG. 4 is a side view of the connector in FIG. 2;

FIG. 5 is a side view of a first component of the connector in FIG. 2;

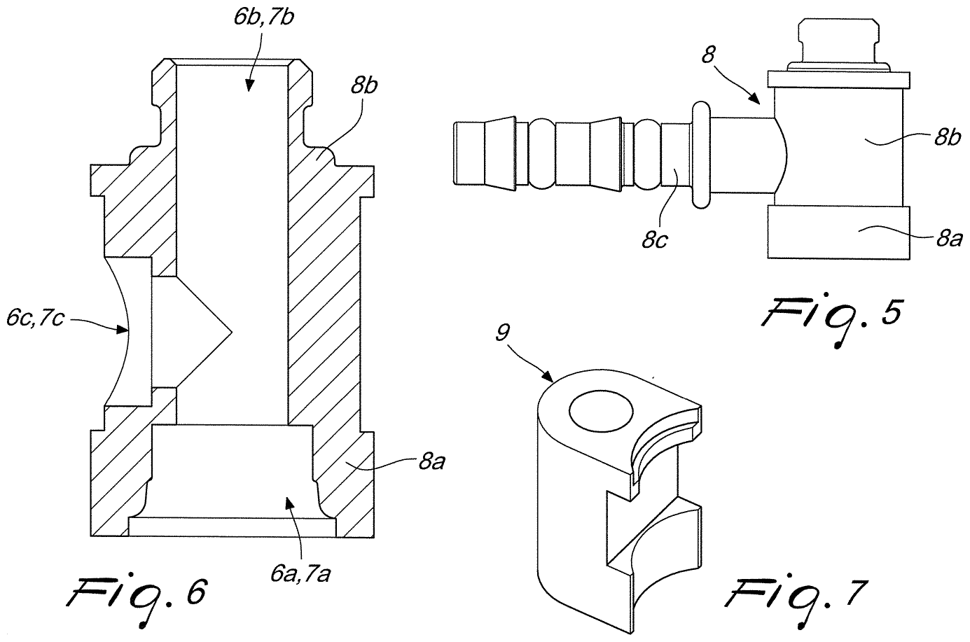

FIG. 6 is an axial cross-sectional view of a detail of FIG. 5;

FIG. 7 is a perspective view of a second component of the connector in FIG. 2.

With particular reference to the figures, the reference numeral 1 generally designates a kit for air conditioning (or climate control) for vehicles, which can be effectively installed on various types of vehicles that are already in circulation or which in any case are already fitted with their own air-conditioning system.

Including according to methods that are known per se, such conditioning system comprises a closed circuit A, in which a heat carrier fluid circulates by virtue of which the system (cyclically) executes a refrigeration cycle, so as to ensure better environmental conditions (in terms of temperature, humidity etc.) inside the driver's cab or the passenger compartment of the vehicle.

More precisely, the circuit closed A is affected at least by a primary compressor B, which is actuated even indirectly by the engine C of the vehicle (for example by way of a belt), by a primary condenser D and by an evaporator E.

It should be noted that such circuit A is usually also affected by a dehydrating filter F, interposed between the primary condenser D and the evaporator E, as can be seen in the accompanying FIG. 1.

The engine C is what provides propulsion to the vehicle, and typically, but not exclusively, it is an internal combustion engine. Precisely because the primary compressor B is entrained in rotation (or otherwise actuated) by the engine C, the air-conditioning system just described is designed to operate only during the motion of the vehicle, or in any case with the engine C running.

In more detail, when the engine C is running the primary compressor B, the primary condenser D and the evaporator E (and the filter F) can be passed through in sequence by the heat carrier fluid, in order to execute the refrigeration cycle. The methods in and of themselves are in any case well known and therefore they are not described further in this discussion. It should be noted in any case that typically such refrigeration cycle lowers the temperature and/or humidity of a compartment of the vehicle (passenger compartment or driver's cab), with which the system is connected, during the motion of the vehicle proper. However, the possibility is not ruled out of operation in reverse, as a heat pump.

It should be noted from this point onward that in the principal application, the kit 1 according to the invention is intended to be installed on heavy vehicles for professional use, such as trucks, semi-trailer trucks and the like, in order to enable (in the ways that will be illustrated below) the control of the environmental conditions in the cabin with the engine C switched off, during the long stops that the drivers of such vehicles make, resting or sleeping inside the cabin proper.

In any case the kit 1 will also be installed on other kinds of vehicles and/or in other situations in which the engine C is in any case switched off. For (non-limiting) example, in an additional application the kit 1 can be installed on air-conditioning systems of security vans, which also make long stops for loading and/or unloading the cargo compartment. In this case therefore, it is the cargo compartment (in addition optionally to the passenger compartment or driver's cab) that is affected by the action of the kit 1.

It should be noted in any case that other applications of the kit 1 are not ruled out, for controlling the environmental conditions of passenger compartments, driver's cabs, cargo compartments or other vehicle compartments of all types.

For example, the kit 1 can be installed on air-conditioning systems of works vehicles (reach trucks, earth-moving machines etc.) or even on systems of completely different vehicles, such as ships or the like.

According to the invention, the kit 1 comprises an auxiliary compressor 2, which is powered with an energy source 3 that is independent of the engine C, which therefore ensures the operation of the auxiliary compressor 2 in the absence of energy from the engine C proper (when the latter is switched off). What is meant by independent energy source 3 is that it is capable of dispensing energy even with the engine C switched off and for example it can optionally coincide with the original battery of the vehicle (the one used to start the engine C proper). Or, while not ruling out other practical implementations, the kit 1 proper can comprise (be sold with) the independent energy source 3, constituted by an accumulator battery (or the like).

Furthermore, the auxiliary compressor 2 is interposed between an intake branch 4 and a delivery branch 5. The intake branch 4 and the delivery branch 5 (for example constituted by respective pipes) are also included in the kit 1.

In the preferred application, and while not ruling out different implementation solutions which are in any case included in the scope of protection claimed herein, the auxiliary compressor 2 is an electric compressor (be it variable-speed or otherwise).

Furthermore, the kit 1 according to the invention comprises a first connector 6, for providing the connection of the intake branch 4 to the intake conduit G, defined by the circuit A, of the primary compressor B.

The kit 1 according to the invention also comprises a second connector 7, for providing the connection of the delivery branch 5 to the delivery conduit H, defined by the circuit A, of the primary compressor B.

In this regard it should be noted that the term intake conduit G (or delivery conduit H) is used to generically mean the entire portion of the circuit A which is comprised between the primary compressor B and the evaporator E (or the primary condenser D): the protection claimed herein extends in fact to the connection of the connector 6, 7 to the circuit A at any point of the respective portion of the circuit A identified above.

The connectors 6, 7 can for example be provided with flanges and/or O-rings, which make the desired hermetic connection possible.

Attention is now drawn to the fact that in the air-conditioning systems for which the kit 1 according to the invention is intended for use, the oil (or other substance) for the lubrication of the primary compressor B is usually dispersed in the heat carrier fluid that circulates in the circuit A to accomplish the refrigeration cycle.

The kit 1 according to the invention therefore also comprises an apparatus for intercepting at least a part of the lubricant (be it oil or another fluid) that is usually dispersed in the heat carrier fluid, in order to prevent the occurrence of the complete emptying of lubricant in the primary compressor B and/or in the auxiliary compressor 2.

By virtue of the connection made with the connectors 6, 7, the auxiliary compressor 2 is in parallel with the primary compressor B, as shown clearly in FIG. 1. In this manner, the kit 1 makes it possible to accomplish a refrigeration cycle with the engine C switched off, but in any case by drawing on much of the circuit A, and in particular the primary condenser D and the evaporator E (and the filter F) which are already present in the system, effectively limiting itself to using the auxiliary compressor 2 which is powered independently by the energy source 3, in place of the primary compressor B.

Therefore from this point onward it is clear that the set aim is achieved in that, first of all, the kit 1 according to the invention can be installed in a vehicle that is already in circulation, or which in any case is provided solely with a system that operates with the engine C running, in order to provide the air conditioning of a compartment of the vehicle with the engine C switched off. Furthermore, since it draws on much of the preexisting system, the kit 1 according to the invention still offers the advantages of the integrated solutions.

It should likewise be noted that typically the kit 1 is intended to be used as a cooling machine for removing heat (lowering the temperature and/or humidity) in the compartment; the possibility is not ruled out however of using it in reverse, as a heat pump.

In a preferred embodiment, cited for the purposes of non-limiting example of the application of the invention, the first connector 6 is of the type with “T” and comprises a first route 6a which can be directly connected to the end of the intake conduit G that is usually intended to be connected to the primary compressor B. Furthermore, the first connector 6 comprises a second route 6b, which can be directly connected to the primary compressor B. So in fact, and as can also be seen from FIG. 2, in such embodiment the first connector 6 is inserted precisely between the intake conduit G and the primary compressor B (and it can be easily connected by temporarily disconnecting these latter items). Furthermore, the first connector 6 comprises a third route 6c which is connected directly to the intake branch 4.

With further reference to the preferred, but non-limiting application of the invention, the second connector 7 is also a T-connector. It comprises a first passage 7a which can be directly connected to the end of the delivery conduit H that is usually intended to be connected to the primary compressor B. Furthermore, the second connector 7 comprises a second passage 7b which can be directly connected to the primary compressor B and a third passage 7c which can be directly connected to the delivery branch 5.

In the preferred embodiment, the second connector 7 is therefore inserted precisely between the primary compressor B and the delivery conduit H (and can be easily connected by temporarily disconnecting these latter items).

While therefore FIG. 1 shows, even if only schematically, connectors 6, 7 that intercept the conduits G, H in a central region thereof, in the preferred embodiment introduced just now (shown in FIG. 2) the connectors 6, 7 are connected respectively downstream of the intake conduit G and upstream of the delivery conduit H, in direct contact with the primary compressor B. These are solutions that in any case are included in the scope of protection claimed herein (which is not limiting of the possible modes of connection of the connectors 6, 7 to the conduits G, H).

It should be noted that the T-connectors 6, 7 can be chosen to be substantially identical or mutually different (in dimensions only, or also in other aspects), according to the specific applicative requirements (for example adapting the dimensions to the various components to which they are or are to be connected).

In the embodiment illustrated in FIGS. 2 to 7, the connectors 6, 7 are substantially identical (optionally apart from the dimensions) and therefore the same paths can represent the routes 6a, 6b, 6c or the passages 7a, 7b, 7c indifferently.

In particular, at least one connector 6, 7, and preferably both, comprises a hollow T-shaped body 8, which with three respective arms 8a, 8b, 8c defines the three routes 6a, 6b, 6c and/or the three passages 7a, 7b, 7c. A first arm 8a is rotatably and hermetically connectable to the respective end of the intake conduit G or of the delivery conduit H. A second arm 8b, arranged on the other side from the first arm 8a (and therefore coaxial with the latter), is rotatably and hermetically connectable to the primary compressor B.

Preferably, the first arm 8a and the second arm 8b are constituted by respective portions of a single cylindrical (or in any case axially symmetric) element.

Furthermore, the third arm 8c (the one connected to the intake branch 4 or to the delivery branch 5 of the auxiliary compressor 2) is substantially perpendicular to and integral with the first arm 8a and with the second arm 8b.

More specifically, the first arm 8a has a “female” shape structure so that it can receive, so that it can rotate, a male connector defined by the respective end of the intake conduit G or of the delivery conduit H. Conversely, the second arm 8b has a “male” shape structure, so that it can be inserted into a seat defined by the primary compressor B.

Effectively, the dimensions and shape of the arms 8a, 8b (or in any case the connectors 6, 7) are chosen to be suitable to be connected (preferably rotatably) to the end of the intake conduit G or of the delivery conduit H and to the primary compressor B.

Conveniently, at least one connector 6, 7, and preferably both, comprises a connection 9 arranged parallel to the first arm 8a and to the second arm 8b. The connection 9 provides the rigid connection of the primary compressor B to the intake conduit G or to the delivery conduit H, thus restoring the connected condition that existed between such components prior to the installation of the kit 1 and the insertion of the connectors 6, 7 in particular.

The body 8 is rotatably associated in a cantilever fashion with the connection 9.

It should be noted therefore that the body 8 is free to rotate with respect to the connection 9; furthermore, although ensuring the necessary seal (by way of flanges or O-rings for example), the body 8 is free to rotate with respect to the primary compressor B and with respect to the conduits G, H, by virtue of the rotating connection of the first arm 8a and of the second arm 8b.

This makes it possible to rotate the third arm 8c at will (FIGS. 3 and 4 show some possible positions in dotted lines), as a function of the installation requirements and in particular of the arrangement of the other components in the preexisting system.

In this way, it is always possible to carry out the installation of the kit 1 according to the invention, and in particular of the connectors 6, 7, without having to cut or in any case permanently modify other components, and this ensures (in addition to a more practical method of installation) the complete reversibility of the kit 1, in that it is possible to install and uninstall it at will, while keeping the original air-conditioning system unaltered.

In a first embodiment of significant practical interest, the interception apparatus introduced in the foregoing pages comprises a liquid separator 10.

The separator 10 is arranged along the delivery branch 5 and is also connected to the auxiliary compressor 2 by way of a recirculation branch 11. The separator 10 can thus intercept at least a part of the lubricant that circulates along the delivery branch 5 (as has been seen, the lubricant is dispersed in the heat carrier fluid and therefore moves with it) and re-send it to the auxiliary compressor 2, through the recirculation branch 11.

The separator 10 therefore plays a very useful role, keeping the kit 1 structurally simple, by taking care of ensuring the reliability of the whole made up of the system and the kit 1, in that it manages the lubricant (oil or the like) of the auxiliary compressor 2 and prevents deficiency of proper lubrication.

In a second embodiment, the interception apparatus comprises at least one first non-return valve 12 and/or at least one second non-return valve 13 (it should be noted therefore, first of all, that the apparatus can have just one first valve 12 or just one second valve 13 or both).

The first non-return valve 12 can be situated upstream of the primary compressor B and/or upstream of the auxiliary compressor 2. The apparatus can likewise comprise a pair of first valves 12, which are arranged in parallel respectively upstream of the primary compressor B and upstream of the auxiliary compressor 2.

In particular, one or two first non-return valves 12 are (preferably but not exclusively) inserted respectively into the second route 6b and/or into the third route 6c of the first connector 6.

In turn, the second non-return valve 13 can be situated downstream of the primary compressor B and/or downstream of the auxiliary compressor 2. The apparatus can likewise comprise a pair of second valves 13, which are arranged in parallel respectively downstream of the primary compressor B and downstream of the auxiliary compressor 2.

In particular, one or two second non-return valves 13 are (preferably but not exclusively) inserted respectively into the second passage 7b and/or into the third passage 7c of the second connector 7.

Such valves 12, 13, respectively on the low-pressure side and on the high-pressure side, prevent the compressor that is operating at that time (either the primary compressor B or the auxiliary compressor 2) from “aspirating” lubricant from the other compressor (the other one of the primary compressor B and the auxiliary compressor 2), thus emptying it of lubricant.

Conveniently, in the preferred embodiment, which does not exhaust the possible implementations which in any case remain within the scope of protection claimed herein, the apparatus comprises both the separator 10 and at least one non-return valve 12, 13.

More precisely, it should be noted that the protection claimed herein should be understood as being extended to apparatuses that comprise one or two (or more) first valves 12 and/or one or two (or more) second valves 13 and/or the separator 10.

Advantageously, the kit 1 according to the invention comprises an electronic unit for independent control and management of the auxiliary compressor 2. Such unit can be an electronic controller, or an electronic device of another nature, and it can also have a respective control panel, in order to allow the user to interact with the kit 1 and its components, controlling and managing its operation autonomously and independently of the scheme of operation of the original air conditioning system fitted on the vehicle.

Conveniently, and while not ruling out other schemes of operation, the unit is configured to impart to the auxiliary compressor 2 an operating mode composed of predefined alternating intervals of power on and power off (chosen preferably, but not exclusively, to be of equal duration). During each power-on interval the auxiliary compressor 2 operates at a preset rotation speed value, preferably (but not exclusively) chosen from either the minimum rotation speed specified for the auxiliary compressor 2 or the rotation speed that corresponds to the maximum energy efficiency of the auxiliary compressor 2. It should be noted that the (electric) auxiliary compressors 2 intended to be part of the kit 1 usually cannot operate at a low number of revolutions (at a low rotation speed), owing to intrinsic structural limitations. By contrast, a low number of revolutions would be appreciated in order to allow limited consumption, in line with the limited availability of electricity usually ensured by the battery of the vehicle or in any case by the source 3.

The alternating of power-on intervals and power-off intervals ensures low consumption in that it determines, if we refer to the average rotation speed value, a behavior comparable to that obtainable with a low value of number of revolutions, although without ever operating directly at such average value. At the same time, the periodic shutdown of the auxiliary compressor 2 does not compromise optimal operation in that the air conditioning provided during the power-on intervals is in any case sufficient to ensure the desired wellbeing.

It should be noted that usually the rotation speed that corresponds to the maximum energy efficiency is equal to the average of the minimum and maximum speeds permitted, and is in any case typically known in advance. Otherwise, in any case the unit can be fitted with a module for identifying it, or in any case for determining it in various ways, according to methods that are well known in the state of the art.

So assuming a work time of one hour, if this is divided into 6 identical intervals of 10 minutes each, cyclically one could for example pass from a punctual cooling power equal for example to 2000 Watts (at the optimal rotation speed value) to one equal to 0 Watts. In this way a total cooling power equal to 1000 Watt/h would be obtained, i.e. half of the power produced.

The electronic unit can be pre-set to disable itself completely (and deactivate the auxiliary compressor 2) when the ignition key is rotated completely (or even only when it is partially rotated, in order to be brought to the position known as “+key”, which usually activates the electrical system of the vehicle). This evidently is in order to ensure that the kit 1 cannot act with the engine C running or indeed with the vehicle in motion (in such conditions in fact, the pre-existing system will be used). This also makes it possible to optimize the energy consumption of the vehicle.

Conveniently, the kit 1 according to the invention also comprises an auxiliary condenser, which is arranged downstream of the auxiliary compressor 2 and which can be arranged in series with the primary condenser D. Obviously, the auxiliary condenser can also be passed through by the heat carrier fluid and it can therefore perform the role of the primary condenser D in order to make the heat carrier fluid perform the refrigeration cycle, when the motor C of the vehicle is switched off.

Conveniently, the kit 1 according to the invention comprises at least one auxiliary fan (and preferably a pair of auxiliary fans), which can be powered by the energy source 3 (be it the battery of the vehicle, a battery supplied with the kit 1, or the like) and which can be arranged proximate to the primary condenser D, so as to cool it even when the engine C is switched off. Should the kit 1 also comprise an auxiliary condenser, the fan (or each fan) can be arranged proximate to the latter, in order to cool it.

It should be noted that typically conditioning systems are already provided with viscostatic fans (especially for heavy vehicles, as in the preferred application of the invention), which are actuated by the engine C and which increase their speed only in the event of an increase in the temperature of the engine C proper. Evidently, during the operation of the auxiliary compressor 2 such fans cannot be used and therefore it is of undoubted practical interest to use the auxiliary fan (or auxiliary fans), in order to obtain the ventilation even when the vehicle is stationary, powered by the energy source 3. In this regard, it should likewise be noted that the speed of the auxiliary fans would be controlled as a function of the pressure measured by a pressure switch fitted on the auxiliary compressor 2.

Use of the kit according to the invention is therefore evident from the foregoing discussion.

The kit 1 can in fact be installed on a vehicle provided with a pre-existing air conditioning system, of the conventional type and operating only with the engine C running By virtue of the connectors 6, 7 in fact, the auxiliary compressor 2 with which the kit 1 is supplied is arranged in parallel with the primary compressor B of the system, which in turn is arranged along the circuit A of the system proper. In this manner, when the engine C is switched off it is possible to use the energy source 3 to power the auxiliary compressor 2: the heat carrier fluid that circulates in the system A therefore passes through, in sequence, the auxiliary compressor 2, the primary condenser D (or the auxiliary condenser), the filter F and the evaporator E in order to air-condition the compartment of interest (the cabin or driver's cab of the vehicle for example, but not only this), with the engine C switched off.

The separator 10 and/or the first valves 12 and/or the second valves 13 make it possible to prevent one of the two compressors B, 2 from being completely emptied of lubricant, during the operation of the other one.

The control panel and the electronic unit make it possible to manage operation completely autonomously and independently of the scheme of operation of the system that was originally fitted on the vehicle. Furthermore the peculiar operating mode imparted by the unit 1 ensures an “intelligent” management of the kit 1 and of the auxiliary compressor 2 in particular, which makes it possible to contain consumption of electricity.

The possibility of rotating the body 8 makes it possible to arrange the intake branch 4 and the delivery branch 5 with their position and orientation chosen at will, so as to adapt them to the spaces available and without needing to intervene on (by moving or, worse, cutting and altering) the original components.

In practice it has been found that the kit 1, although sold and installed separately on vehicles that are already in circulation, shares most of the components with the pre-existing system and therefore has the advantages of integrated solutions.

In more detail, this sharing entails that first of all that the kit 1 keeps the number of components low and also keeps the weight on the vehicle low.

Furthermore, by using the existing components and attachment points, the kit 1 can be installed on the vehicle of interest, without requiring holes in walls or the use of hatches, and more generally without entailing elements mounted outside the cabin (or other compartment to be climate-controlled) and therefore without modifying the aerodynamic profile of the vehicle proper.

As has been seen, the kit 1 can be effectively used for vehicles for professional use, such as trucks, semi-trailer trucks and the like, or even for security vans, works vehicles, ships etc. In such contexts, the kit 1 enables control of the environmental conditions during the parking of the vehicle.

It must be emphasized however that a further application (including for private use) is constituted by those cases where it is desired to convert a vehicle with an internal combustion engine C to a vehicle that is (at least partially) propelled electrically. In such situation in fact, by virtue of the kit 1 according to the invention it is possible to retain all the components of the vehicle proper (with regard to the air conditioning system) and use it in combination with an electric auxiliary compressor 2.

This makes it possible to define a kit 1 that can be effectively used if it is desired to convert a vehicle with an internal combustion engine C to an electric vehicle, without having to redesign the air conditioning system but instead easily adapting it to the new use of the vehicle. Likewise, if the vehicle is converted to operate both with electricity and with fuel, by virtue of the kit 1 the pre-existing air conditioning system would be reconverted to operate in both modes.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

1.-16. (canceled)

17. An air conditioning kit for vehicles, said vehicles being provided with an air conditioning system that comprises a closed circuit which is affected at least by a primary compressor, which is actuated directly or indirectly by the engine of the vehicle, by a primary condenser and by an evaporator, which can all be passed through in sequence by a heat carrier fluid, circulating in the circuit, in order to accomplish a refrigeration cycle, and further comprising:
an auxiliary compressor, configured to be powered with an energy source that is independent of the engine and which optionally coincides with the original battery of the vehicle, said auxiliary compressor being interposed between an intake branch and a delivery branch,
a first connector, for a connection of said intake branch to an intake conduit, defined by the circuit, of the primary compressor,
a second connector, for a connection of said delivery branch to a delivery conduit, defined by the closed circuit, of the primary compressor,
an apparatus for intercepting at least a part of the lubricant that is usually dispersed in the heat carrier fluid, in order to prevent a complete emptying of lubricant in the primary compressor and/or in said auxiliary compressor.

18. The kit according to claim 17, further comprising said energy source, constituted by an accumulator battery.

19. The kit according to claim 17, wherein said auxiliary compressor is an electric compressor.

20. The kit according to claim 17, wherein said first connector is a T-connector and comprises a first route which is configured to be directly connected to an end of the intake conduit that is usually intended to be connected to the primary compressor, a second route which is configured to be directly connected to the primary compressor, and a third route which is directly connected to said intake branch.

21. The kit according to claim 20, wherein said second connector is a T-connector and comprises a first passage which is configured to be directly connected to an end of the delivery conduit that is usually intended to be connected to the primary compressor, a second passage which is configured to be directly connected to the primary compressor, and a third passage which is directly connected to said delivery branch.

22. The kit according to claim 21, wherein at least one of said first and second connectors comprises a T-shaped hollow body, which with three respective arms defines said first, second and third routes and/or said first, second and third passages, a first arm being rotatably and hermetically connectable to the respective end of the intake conduit or of the delivery conduit, a second arm, arranged on another side from said first arm, being rotatably and hermetically connectable to the primary compressor, a third arm being substantially perpendicular to and integral with said first arm and with said second arm.

23. The kit according to claim 22, wherein at least one of said first and second connectors comprises a connection arranged parallel to said first arm and to said second arm, for rigidly connecting the primary compressor to the intake conduit or to the delivery conduit, said T-shaped hollow body being rotatably associated in a cantilever fashion with said connection.

24. The kit according to claim 21, wherein said apparatus comprises a liquid separator, which is arranged along said delivery branch and is also connected to said auxiliary compressor by way of a recirculation branch, in order to intercept at least a part of the lubricant that circulates along said delivery branch and resend it to said auxiliary compressor, through said recirculation branch.

25. The kit according to claim 21, wherein said apparatus comprises at least one first non-return valve, which is configured to be arranged upstream of the primary compressor and/or upstream of said auxiliary compressor, and/or at least one second non-return valve, which can be arranged downstream of the primary compressor and/or downstream of said auxiliary compressor.

26. The kit according to claim 25, wherein said at least one first non-return valve is inserted respectively into said second route and/or into said third route of said first connector.

27. The kit according to claim 25, wherein said at least one second non-return valve is inserted respectively into said second passage and/or into said third passage of said second connector.

28. The kit according to claim 25, wherein said apparatus comprises said liquid separator and at least one said first and second non-return valves.

29. The kit according to claim 17, further comprising an electronic unit for independent control and management of said auxiliary compressor, which is also associated with a respective control panel.

30. The kit according to claim 29, wherein said electronic unit is configured to assign said auxiliary compressor an operating mode that is composed of predefined alternating intervals of power on and power off, during each one of said power-on intervals said auxiliary compressor operating at a preset rotation speed, preferably chosen from either the minimum rotation speed specified for said auxiliary compressor or the rotation speed that corresponds to a maximum energy efficiency of said auxiliary compressor.

31. The kit according to claim 17, further comprising an auxiliary condenser, which is arranged downstream of said auxiliary compressor and which is configured to be arranged in series with the primary condenser.

32. The kit according to claim 31, further comprising at least one auxiliary fan, which is configured to be powered by said energy source and configured to be arranged proximate to the primary condenser for the cooling thereof even when the engine is switched off and/or proximate to said auxiliary condenser, for the cooling thereof.
